(19) United States
(12) Patent Application Publication
(10) Pub. No.: US 2017/0237847 A1
(43) Pub. Date: Aug. 17, 2017

(54) ENABLING AND DISABLING A DISPLAY OF MOBILE COMMUNICATION DEVICE

(71) Applicant: GEELUX HOLDINGS, LTD., Tortola (VG)

(72) Inventor: Marcio Marc ABREU, Bridgeport, CT (US)

(73) Assignee: GEELUX HOLDINGS, LTD., Tortola (VG)

(21) Appl. No.: 15/429,639

(22) Filed: Feb. 10, 2017

Related U.S. Application Data
(60) Provisional application No. 62/293,919, filed on Feb. 11, 2016.

(51) Int. Cl. H04M 1/725

(52) U.S. Cl. CPC H04M 1/72519

(57) ABSTRACT

A mobile communication device is configured to prevent input to at least a portion of a display of the mobile communication device when the mobile communication device is being used for communication and when orientation of the device is such that the mobile communication device is positioned for such communication while being held in a hand of a user.

### CROSS-REFERENCE TO RELATED APPLICATIONS

This application claims the benefit of priority to U.S. Provisional Patent Application No. 62/293,919, filed on Feb. 11, 2016, which is hereby incorporated by reference in its entirety.

### TECHNICAL FIELD

This disclosure relates to controlling a display of a mobile communication device when using the device for communication while holding the device.

### BACKGROUND

When a conventional mobile communication device is operated, it is typical to set the device on a surface, i.e., it is typical to operate the device without contacting the device, or the device is held in a hand on an opposite side of the device from a display of the device. In such conventional devices, the display remains active unless the display “sleeps” after a predetermined interval.

### SUMMARY

This disclosure provides a mobile communication device, comprising a casing, a display, a microphone, an antenna, and a speaker. The display, the microphone, the antenna, and the speaker are positioned on or in the casing, and the display includes an input device. The antenna is configured to wirelessly transmit signals received from the microphone, and to receive signals transmitted wirelessly. The speaker is configured to emit audio signals based upon the wirelessly received signals from the antenna. When the mobile communication device wirelessly transmits signals received from the microphone and wirelessly receives signals that are converted to audio by the speaker, at least a portion of the display is automatically disabled from receiving an input from the input device.

This disclosure also provides a mobile communication device, comprising a casing, a display, a microphone, an antenna, and a speaker. The casing includes a front side, a back side, and a plurality of sides connecting the front side to the back side. The display is positioned on or in the front side of the casing, and the display includes an input device that operates by at least one of a proximity to, a contact with, and a pressure on a surface of the display by an object. The microphone is positioned in, on, or adjacent to one of the plurality of sides connecting the front side to the back side. The antenna is positioned on or in the casing, and the antenna is configured to wirelessly transmit signals received from the microphone and to wirelessly receive signals. The speaker is positioned in, on, or adjacent to the same one of the plurality of sides connecting the front side to the back side, and the speaker is configured to emit audio signals based upon the wirelessly received signals from the antenna. When the mobile communication device wirelessly transmits signals received from the microphone and wirelessly receives signals that are converted to audio by the speaker, at least a portion of the display is automatically disabled from receiving an input from the input device.

This disclosure also provides a mobile communication device, comprising a housing, a display, a microphone, an antenna, and a speaker. The housing or casing includes a front side, a back side, and a plurality of sides connecting the front side to the back side. The display is positioned on or in the front side of the housing or casing, and the display includes an input device that operates by at least one of a proximity to, a contact with, and a pressure on a surface of the display by an object. The microphone is positioned in, on, or adjacent to one of the plurality of sides connecting the front side to the back side. The antenna is positioned on or in the housing or casing. The antenna is configured to wirelessly transmit signals received from the microphone, and to wirelessly receive signals. The speaker is positioned on or in the housing or casing at a location that is spaced away from a top of the housing or casing, and the speaker is configured to emit audio signals based upon the wirelessly received signals from the antenna. When the mobile communication device wirelessly transmits signals received from the microphone and wirelessly receives signals that are converted to audio by the speaker, at least a portion of the display is automatically disabled from receiving an input from the input device.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 shows a perspective view of a conventional mobile communication device.

FIG. 2 shows a perspective view of a mobile communication device in accordance with an exemplary embodiment of the present disclosure with portions of a housing or casing of the mobile communication device removed.

FIG. 3 shows a view of the mobile communication device of FIG. 2 being operated by a user.

FIG. 4 shows a block diagram of the mobile communication device of FIG. 2.

FIG. 5 shows a perspective view of a mobile communication device in accordance with an exemplary embodiment of the present disclosure.

FIG. 6 shows a view of the mobile communication device of FIG. 5 being operated by a user.

FIG. 7 shows a view of a mobile communication device in accordance with another exemplary embodiment of the present disclosure being operated by a user.

FIG. 8 shows a view of a mobile communication device in accordance with yet another exemplary embodiment of the present disclosure being actuated by a user.

FIG. 9 shows a view of the mobile communication device of FIG. 8 in communicative operation by the user.

FIG. 10 shows a process flow in accordance with an exemplary embodiment of the present disclosure.

FIG. 11 shows a view of a mobile communication device in accordance with an exemplary embodiment of the present disclosure.

FIG. 12 shows a further view of the mobile communication device of FIG. 11.

FIG. 13 shows a view of a mobile communication device in accordance with a further exemplary embodiment of the present disclosure.

FIG. 14 shows a further view of the mobile communication device of FIG. 11.

FIG. 15 shows a view of a mobile communication device in accordance with a yet further exemplary embodiment of the present disclosure.

### DETAILED DESCRIPTION

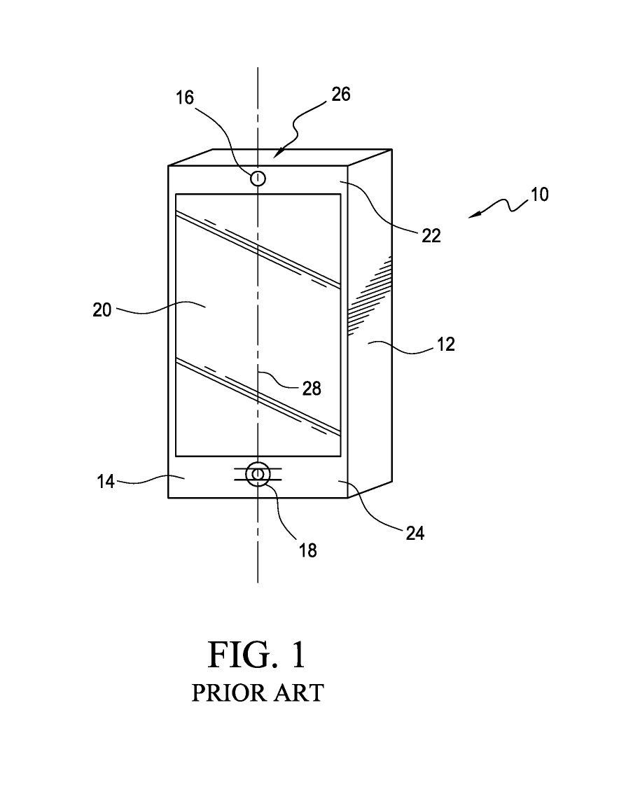

Mobile communication devices share common features. Referring to FIG. 1, a conventional mobile communication device, indicated generally at 10, includes a housing or case 12 configured to support various elements of mobile communication device 10. Housing 12 includes a front face 14, and located in or on front face 14 is a speaker 16, a microphone 18, and a display 20 positioned longitudinally between speaker 16 and microphone 18. Generally, the end or location of mobile communication device 10 where speaker 16 is located is considered a top 22 of mobile communication device 10, and thus is also the top of housing 12, and the end or location of mobile communication device 10 where microphone 18 is located is considered a bottom 24 of mobile communication device 10, and thus is also the bottom of housing 12. Speaker 16 and microphone 18 are located near a longitudinal centerline 28 to position speaker 16 near an ear of a user and to position microphone 18 near a mouth of the user when mobile communication device 10 is positioned at, near, on, adjacent, or in proximity to a face of a user. Mobile communication device 10 further includes an antenna 26 for wireless communication, including wireless transmission and wireless reception, and antenna 26 can be positioned internal or external to housing or casing 12, including partially internal and partially external to housing or casing 12. Housing or casing 12 can also include antenna 26 integrally formed therewith. Antenna 26 can be positioned in one of a plurality of locations internal to, external to, or integrally with housing or casing 12.

While conventional mobile communication devices 10 work well for their intended purpose, antenna 26 transmits or radiates electromagnetic radio frequency (RF) energy, including microwave frequencies, and it is believed that exposure to these types of energy may lead to tissue damage and potentially cancer. In addition, mobile communication device 10 emits heat. Accordingly, Applicant developed mobile communication device configurations that reduce exposure to RF radiation, as well as thermal radiation, as disclosed in U.S. patent application Ser. No. 15/419,945, filed on Jan. 30, 2017, which is incorporated herein by reference in its entirety. While configurations that reduce exposure to RF radiation and thermal radiation are potentially beneficial to the user, such configurations can position a hand and/or fingers such that a display is touched, yielding undesirable control of the mobile communication device. Accordingly, the present disclosure includes a mobile communication device configured to reduce the risk of inadvertent input to the display of the mobile communication device when the mobile communication device is being used for communication and/or when orientation of the device is such that the mobile communication device is positioned for such communication while being held in the hand of the user. It should be understood that the mobile communication devices disclosed herein are representative of mobile communication devices with speakers and microphones positioned in non-traditional locations for a device configured to be supported by a single hand. In other words, the speakers described herein are in a location other than a top of a housing or casing, or are adjacent to a same side connected to a front face of a mobile communication device as a speaker.

Many aspects of the disclosure are described in terms of sequences of actions to be performed by elements of a computer system or other hardware capable of executing programmed instructions, for example, a general-purpose computer, special purpose computer, workstation, or other programmable data process apparatus. It will be recognized that in each of the embodiments, the various actions could be performed by specialized circuits (e.g., discrete logic gates interconnected to perform a specialized function), by program instructions (software), such as program modules, being executed by one or more processors (e.g., one or more microprocessors, a central processing unit (CPU), and/or application specific integrated circuit), or by a combination of both. For example, embodiments can be implemented in hardware, software, firmware, microcode, or any combination thereof. The instructions can be program code or code segments that perform necessary tasks and can be stored in a non-transitory machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information. It should be noted that the system of the present disclosure is illustrated and discussed herein as having various modules and units that perform particular functions.

It should be understood that these modules and units are merely described based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Input/output or I/O devices or user interfaces including, but not limited to, keyboards, displays, pointing devices, and the like can be coupled to the system either directly or through intervening I/O controllers. Thus, the various aspects of the disclosure may be embodied in many different forms, and all such forms are contemplated to be within the scope of the disclosure.

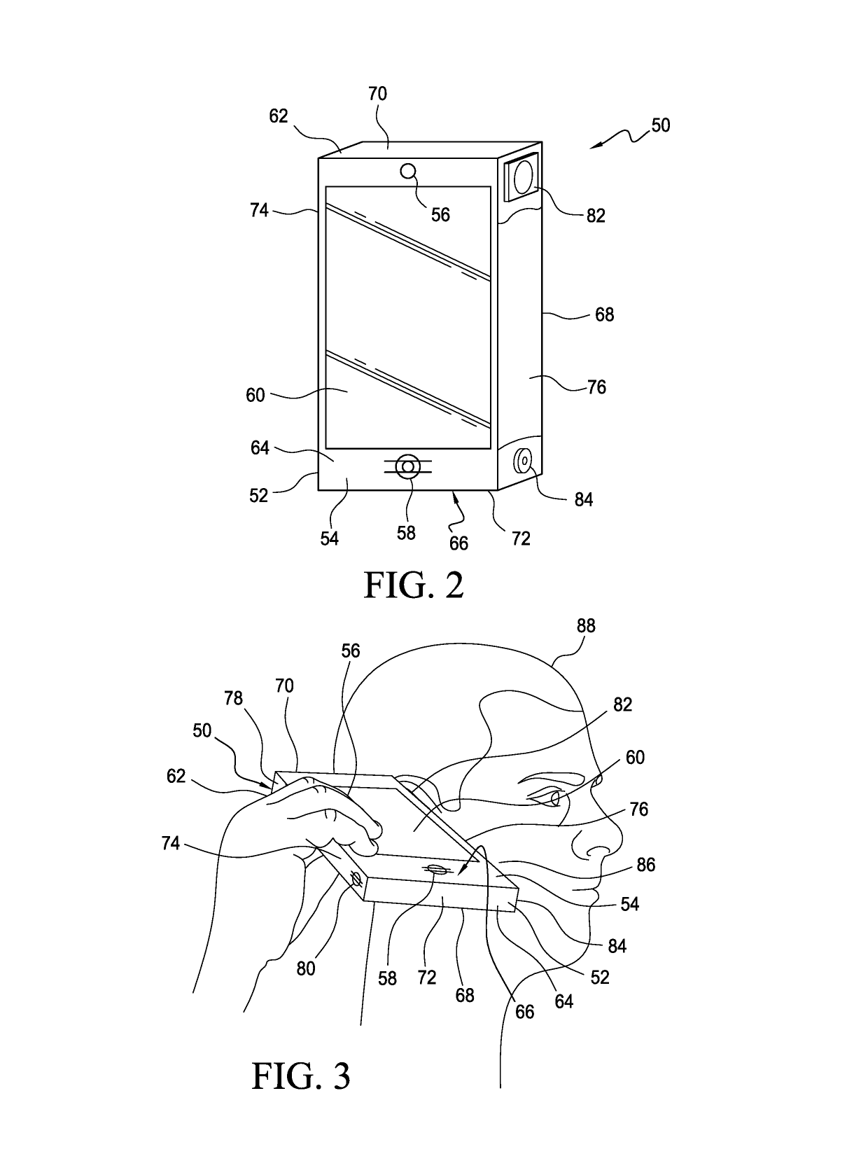

FIGS. 2-4 show a mobile communication device, indicated generally at 50, in accordance with an exemplary embodiment of the present disclosure. Mobile communication device 50 includes a casing or housing 52 configured to support various elements of mobile communication device 50, which can be internally or externally positioned on or in casing or housing 52. Housing 52 includes a front face 54, and front face 54 can include and support a speaker 56, a microphone 58, and a display 60 positioned longitudinally between speaker 56 and microphone 58 along a line. Generally, the end or location of mobile communication device 50 where speaker 56 is positioned and located is considered a top 62 of mobile communication device 50, and thus is also the top of housing 52, and the end or location of mobile communication device 50 where microphone 58 is located is considered a bottom 64 of mobile communication device 50, and thus is also the bottom of housing 52. Mobile communication device 50 further includes an antenna 66 for wireless communication, including wireless transmission and wireless reception. Antenna 66 can be positioned at or near top 62, or at or near bottom 64, as shown in FIGS. 2-4, with at least a portion of antenna 66 being internal to housing 52 of mobile communication device 10. It should be understood that the entirety of antenna 66 can be positioned internal to housing 52, as shown in FIG. 3, external to housing 52, partially internal and partially external to housing 52, or as part of an internal or external location of housing or casing 52.

Housing 52 further includes a rear or back face 68. Extending between back face 68 and front face 54 are a plurality of side faces, including a top side face 70, a bottom side face 72, a left side face 74, and a right side face 76. In the embodiment of FIGS. 2-4, left side face 74 is configured to include a left speaker 78 and a left microphone 80, and right side face 76 is configured to include a right speaker 82 and a right microphone 84. It should be understood that in another embodiment, only left speaker 78 and left microphone 80 might be present, in yet another embodiment, only right speaker 82 and right microphone 84 might be present, and in yet a further embodiment, any combination of front face speaker 56, left speaker 78, and right speaker 82 might be present as long as at least one left speaker 78 or one right speaker 82 is present and any combination of bottom microphone 58, left microphone 80, and right microphone 84 might be present as long as at least one left microphone 80 or one right microphone 84 is present.

Mobile communication device 50 is configured to be held by the user such that one of front face 54, left side face 74, or right side face 76 is positioned directly adjacent as a closest side or surface to a face 86 of a user 88, thus positioning at least a portion of antenna 66, which extends across top 62 of mobile communication device 50, as shown in FIG. 3, away from user 88. It should be understood that communication device 50, for the purposes of the present disclosure, can include any device that includes an RF transmitter and is configured to be positioned on, at, adjacent, near, alongside, or in proximity to the user's ear, which may include a cellular phone, a telephone, a music player, a media device, a medical device, GPS systems, a military device, any wireless device, and the like.

FIG. 3 shows mobile communication device 50 being utilized by user 88 during operation, in which right side face 76 of mobile communication device 50 is the only portion of mobile communication device 50 adjacent to or in contact with face 86 of user 88. In this embodiment, speaker 82 is positioned near, adjacent, or on an ear of user 88 and microphone 84 is positioned near or adjacent to a mouth of user 88. Although FIG. 3 shows left speaker 78 and left microphone 80, centrally positioned speaker 56, and centrally positioned microphone 58, it should be understood, as has already been described in this disclosure hereinabove, that mobile communication device 50 can include only speaker 82 and microphone 84. Alternatively, mobile communication device 50 can include only speaker 78 and microphone 80.

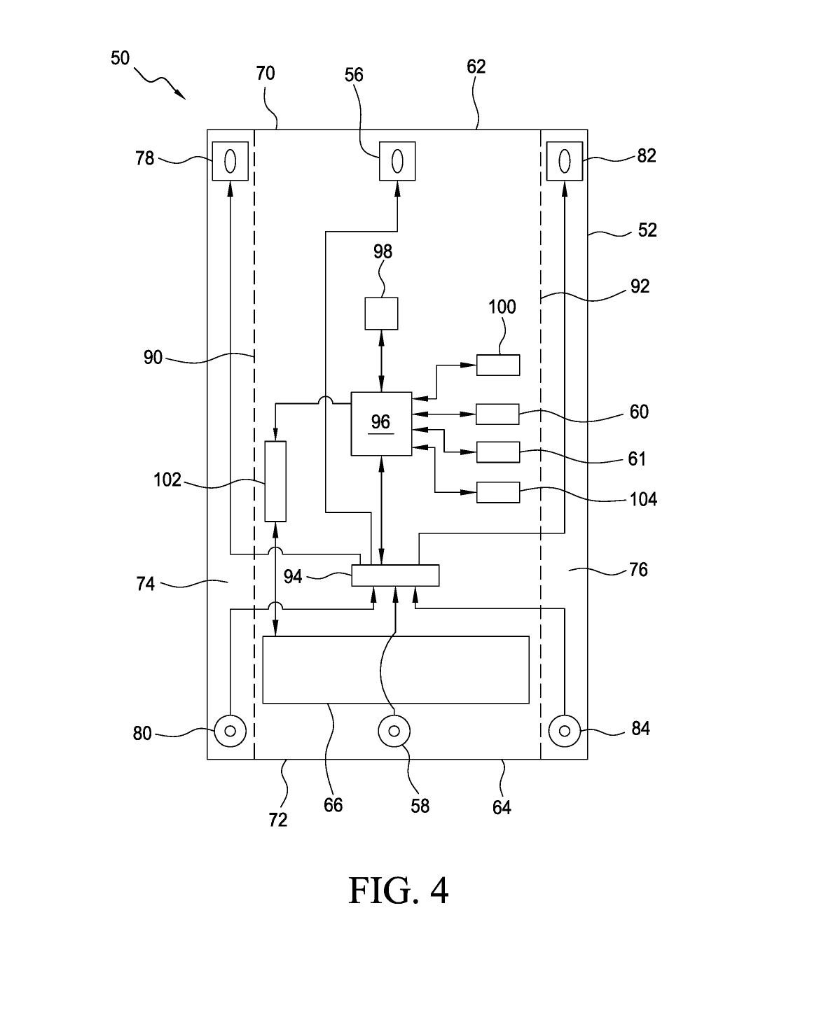

FIG. 4 shows the approximate position of certain internal elements of mobile communication device 50 in a stylized manner. Note that left side face 74 and right side face 76 are delineated by dashed lines 90 and 92, respectively. In addition to speaker 56, microphone 58, left speaker 78, right speaker 82, left microphone 80, and right microphone 84, mobile communication device 50 includes an analog-to-digital (A/D) converter 94, a processor 96, a sim card 98, a non-transient memory 100, a transceiver 102, and an orientation system 104. It should be understood that while a single A/D converter 94 is shown, a plurality of individual A/D converters can be used in place of A/D converter 94. It should be further understood that while a single processor 96 is shown, a plurality of processors can be used to perform the operations and function of mobile communication device 50. Similarly, while a single non-transient memory 100 is shown, mobile communication device 50 can include a plurality of non-transient memories. Furthermore, while a single display 60 is shown, mobile communication device 50 can include a plurality of displays.

A/D converter 94 converts digital signals from processor 96 to analog signals to drive speaker 56, left speaker 78, and right speaker 82, which then emit audio signals that can be in a frequency range of 20 Hz to 20,000 Hz. A/D converter 94 further converts analog signals from microphone 58, left microphone 80, and right microphone 84 to digital signals for input into processor 96, which can then be sent to antenna 66 for wireless transmission. Though not shown, mobile communication device 50 can include amplifiers to amplify the analog signals to and from A/D converter 94 and filters to clean up the analog signals transmitted to A/D converter 94 by reducing noise. It should be understood that left side face 74 and right side face 76 can include a side display, and in this embodiment a respective side speaker and a respective side microphone would be disposed adjacent to said side display or as part of said side display. It should also be understood that a speaker and a microphone can be disposed as part of front display 60.

Processor 96 receives data from sim card 98 and non-transient memory 100 that enables mobile communication device 50 to communicate via transceiver 102 and antenna 66 with a cell phone network and perform a variety of functions. It should be understood that transceiver 102 includes the function of a transmitter and a receiver for wireless transmission and wireless reception, and the term transceiver does not denote any particular configuration of transmitter and receiver. Accordingly, transceiver 102 can be a transmitter and receiver 102, a transmitter-receiver 102, or a transceiver 102. Processor 96 further communicates with display 60, including receiving touch and/or force information from display 60 or a sensor 61 associated with display 60. Orientation system 104 includes elements that function to determine the orientation of mobile communication device 50. Such elements can include, for example, accelerometers, tilt sensors, magnetic sensors, gyroscopes, and other such devices that can measure orientation. It should be understood that orientation system 104 can include elements configured to determine the orientation of mobile communication device 50 with respect to face 86 of user 88. The operation of orientation system 104 is described in more detail hereinbelow.

As should be apparent from FIG. 3, when mobile communication device 50 is used as shown in FIG. 3, the hand and/or fingers of user 88 can easily contact display 60, thus operating or actuating display 60 by way of sensors, such as sensors 61 shown in FIG. 4.

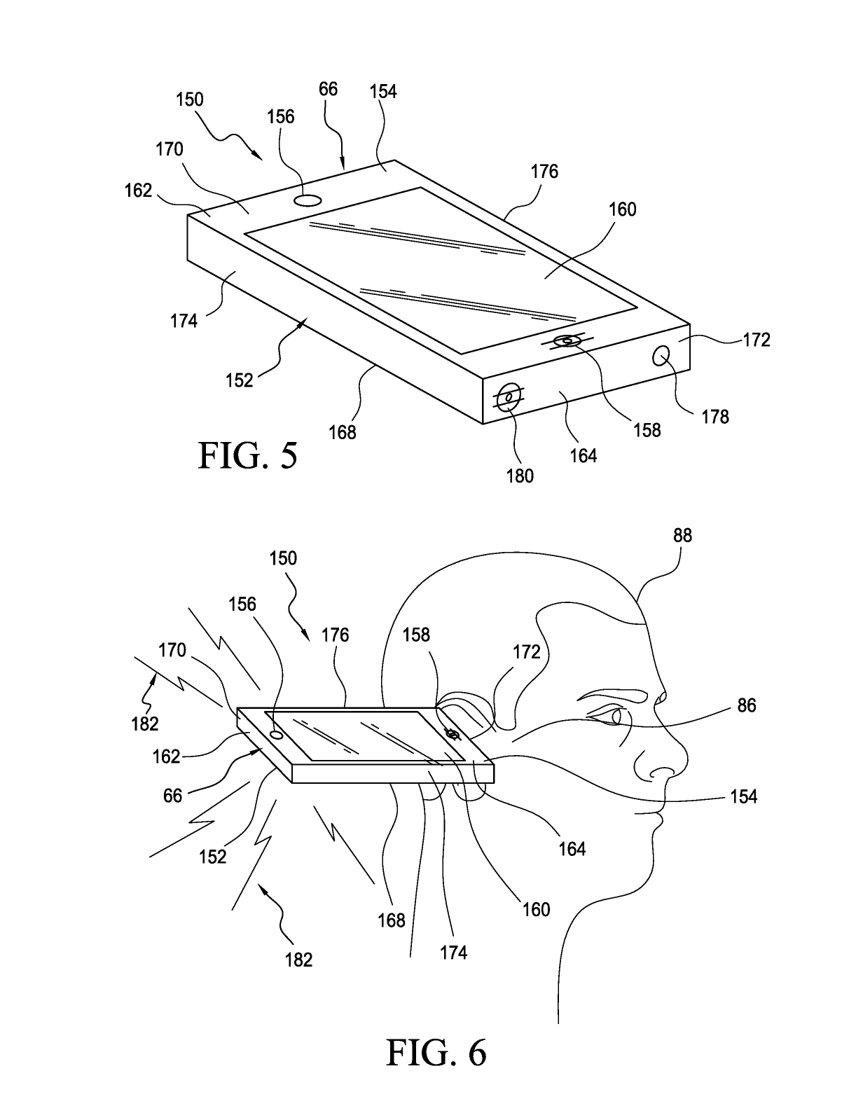

FIGS. 5 and 6 are views of a mobile communication device, indicated generally at 150, in accordance with an exemplary embodiment of the present disclosure. In FIGS. 5 and 6, elements that are configured similarly to previously described elements are provided with the number assigned in the previous embodiment described hereinabove for the sake of brevity.

Mobile communication device 150 includes a casing or housing 152 configured to contain or support various elements of mobile communication device 150, which can be positioned internally to casing or housing 152, externally to casing or housing 152, as a part of casing or housing 152, or any combination of internal to, external to, and part of casing or housing 152. Housing 152 includes a front face 154, and located on or in front face 154 can be a speaker 156, a microphone 158, and a display 160 positioned longitudinally between speaker 156 and microphone 158. Generally, the end or location of mobile communication device 150 where speaker 156 is located is considered a top 162 of mobile communication device 150, and thus is also the top of housing 152, and the end or location of mobile communication device 150 where microphone 158 is located is considered a bottom 164 of mobile communication device 150, and thus is also the bottom of housing 152. Mobile communication device 150 further includes antenna 66, similar to mobile communication device 50.

Housing 152 further yet includes a back face 168. Extending between back face 168 and front face 154 are a plurality of side faces, including a top side face 170, a bottom side face 172, a left side face 174, and a right side face 176. In the embodiment of FIGS. 5 and 6, bottom side face 172 is configured to include a bottom speaker 178 and a bottom microphone 180. It should be understood that while bottom speaker 178 is shown at, near, alongside, adjacent, or in proximity to an intersection of bottom side face 172 and right side face 176, and bottom microphone 180 is shown at, near, alongside, adjacent or in proximity to an intersection of bottom side face 172 and left side face 174, the positions of bottom speaker 178 and bottom microphone 180 can be reversed such that bottom speaker 178 is at, near, alongside, adjacent, or in proximity the intersection of bottom side face 172 and left side face 174 and bottom microphone 180 is at, near, alongside, adjacent or in proximity to the intersection of bottom side face 172 and right side face 176

Mobile communication device 150 is configured to be held such that one of front face 154 or bottom side face 172 is positioned immediately adjacent to face 86 of user 88, thus positioning antenna 66, and radiation 182 emitted by antenna 66, a furthest possible distance away from user 88 while using mobile communication device 150 without being in a speakerphone mode.

FIG. 6 shows mobile communication device 150 being utilized by user 88 during operation, in which bottom side face 172 of mobile communication device 150 is the only portion of mobile communication device 150 that is directly adjacent, near, or in contact with face 86 of user 88. Bottom speaker 178 is positioned near to, on, alongside, adjacent, or in proximity to an ear of user 88 and bottom microphone 180 is positioned near to, on, alongside, adjacent, or in proximity to the mouth of user 88. Although FIG. 6 shows centrally positioned speaker 156 and centrally positioned microphone 158, it should be understood, as has already been explained hereinabove, that mobile communication device 150 may include only bottom speaker 178 and bottom microphone 180.

As with the embodiment shown in FIGS. 2 and 3, when mobile communication device 150 is used as shown in FIG. 6, the hand and/or fingers of user 88 naturally wrap around mobile communication device 150, coming into contact with display 160, thus inadvertently or undesirably operating or actuating display 160 by way of sensors, such as sensors 61 shown in FIG. 4.

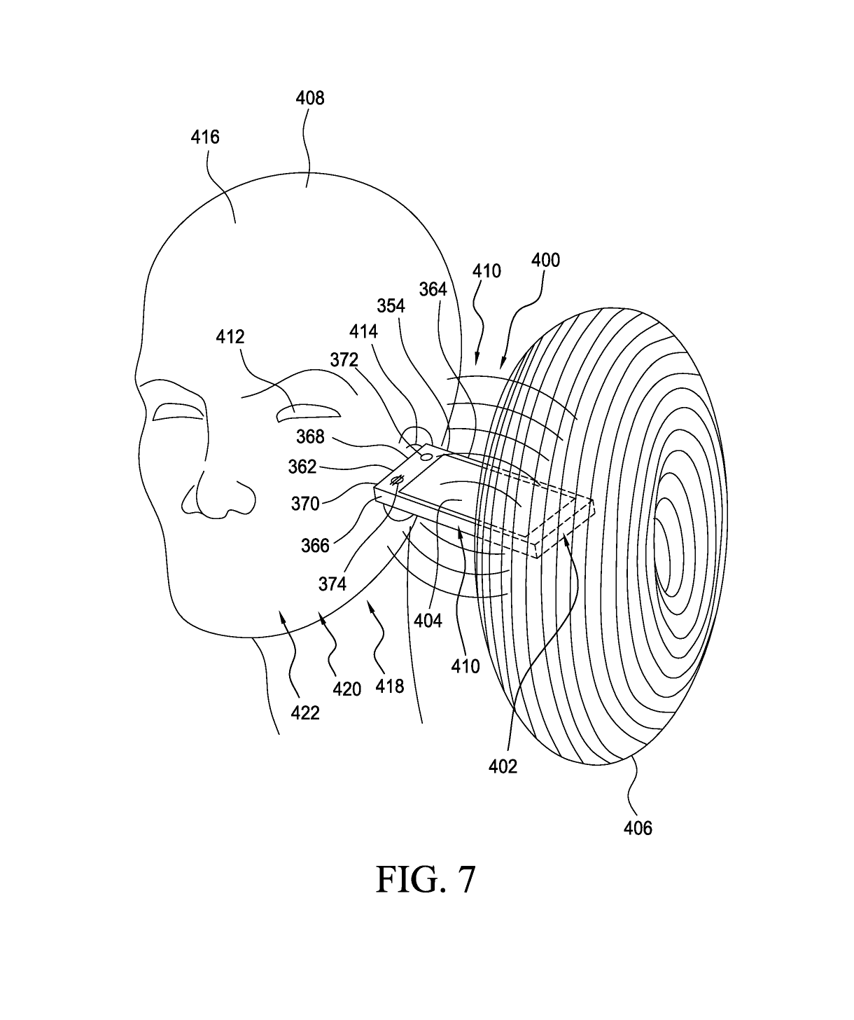

FIG. 7 shows a view of a mobile communication device, shown generally at 400, in accordance with another exemplary embodiment of the present disclosure being operated by a user. Mobile communication device 400 includes a bottom speaker 368 and a bottom microphone 370 located in a bottom side face 362. In addition, a front face 354 of device 400 includes a front face speaker 372 positioned on front face 354 longitudinally between a display 404 located on or in front face 354 and bottom speaker 368, and a front face microphone 374 positioned on front face 354 longitudinally between display 404 and bottom microphone 370. Thus, front face speaker 372 and front face microphone 374 are positioned along a bottom portion of front face 354 that is adjacent or in proximity to bottom side face 362. The configuration of mobile communication device 400 is such that a user automatically knows that bottom speaker 368 and bottom microphone 370 are on an opposite end of mobile communication device 402 from an antenna 402. Thus, antenna 402 can be disposed in a location that is diametrically opposed to bottom speaker 368 and bottom microphone 370. In addition, front face speaker 372 and front face microphone 374 are positioned on front face 354 in a location that is spaced as far from antenna 402 as possible.

It should be apparent that while bottom speaker 368 and front face speaker 372 are positioned adjacent to a left side face 364, and bottom microphone 370 and front face microphone 374 are positioned adjacent to a right side face 366, the positions of these features can be reversed such that bottom speaker 368 and front face speaker 372 are positioned adjacent to right side face 366 and bottom microphone 370 and front face microphone 374 are positioned adjacent to left side face 364.

Antenna 402 generates an electromagnetic or radio-frequency radiation pattern 406 that is positioned away from a head 408 of a user by virtue of the location of speaker 368 and microphone 370, and the orientation of mobile communication device 400 with respect to head 408. In addition, internal electronics to mobile communication device 400 generate thermal or heat radiation 410, and heat radiation 410, which provides unnecessary and potentially damaging thermal energy to the face and organs of head 408, such as eyes 412, ears 414, brain 416, and the salivary glands, including parotid gland 418, sublingual gland 420, and submandibular gland 422. It should be understood that the orientation of mobile communication device 400 with respect to head 408 can be described as away from, transverse to, or perpendicular to head 408.

As with previously described embodiments, when holding mobile communication device 400 as shown in FIG. 7, the fingers and hand of the user can readily touch display 404, potentially causing undesirable or inadvertent actuation of mobile communication device 400.

To prevent undesirable actuation of a mobile communication device when the mobile communication device is held such that the fingers of the user touch the display of the mobile communication device, the mobile communication device can be configured to disable a display of the mobile communication device when a call is made, even though the display is illuminated and may be presenting an image. As an alternative, the mobile communication device can include orientation system 104. When the mobile communication system is used to make a call, and when orientation system 104 detects that the mobile communication device is oriented such that the fingers of the user is likely to contact the display, the mobile communication device disables input from at least a portion of the display to reduce or prevent inadvertent actuation of the mobile communication device by way of the display. Thus, in discussion of an operator disabling and enabling a display provided hereinbelow, it should be understood that an orientation device or system could also provide such capability, potentially in combination with other sensors indicating how the mobile communication device is held. However, such systems can be unreliable because the user can be oriented in many unexpected positions, thus, a manual entry by the user may be preferred.

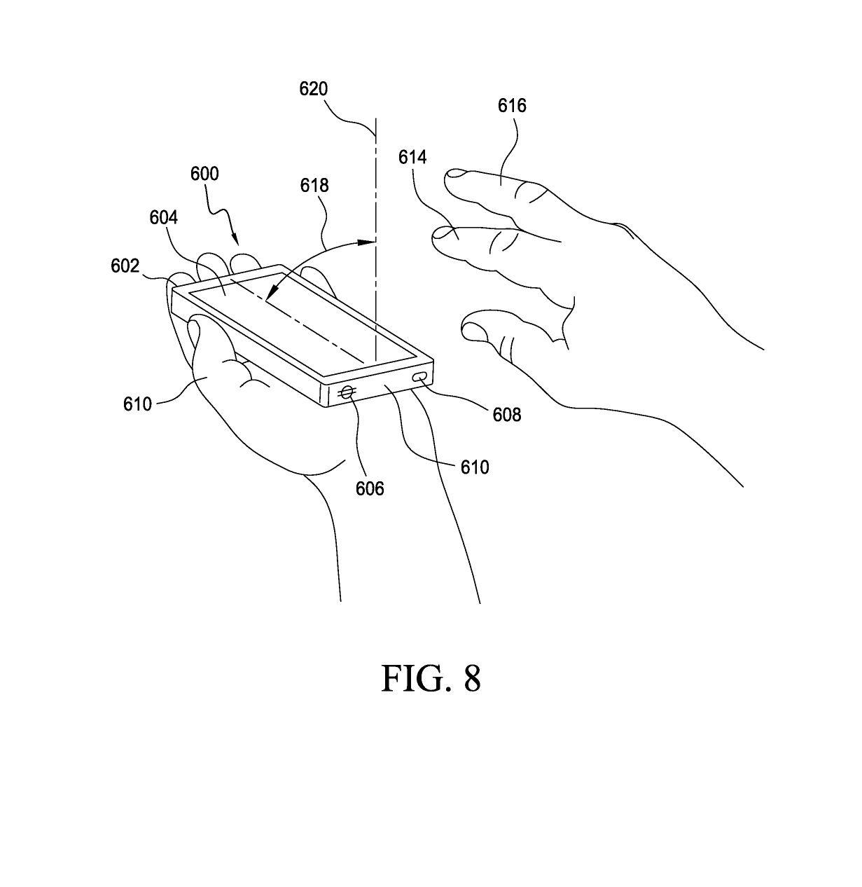

FIG. 8 shows a view of a mobile communication device, indicated generally at 600, in accordance with an exemplary embodiment of the present disclosure. Mobile communication device 600 includes a housing or casing 602, a display 604, a microphone 606, and a speaker 608. Microphone 606 and speaker 608 can be configured as described in previous embodiments, or can be positioned on an end or end face 610 of housing or casing 602 of device 600. When accessing a phone list or entering a telephone number to make a call, device 600 is typically held in a first hand 612 while a finger 614 of a second hand 616 provides an input to display 604. A sensor, such as sensor 61 described herein, can be a pressure sensor, touch sensor, capacitive sensor, and/or an optical sensor configured to detect proximity, contact, or pressure on display 604 by an object, such as a finger or thumb, to select features displayed on display 604, such as a phone list entry, or numbers of a phone. Thus, sensor 61 can be described as an input device. When operating mobile communication device 600 in the manner described, device 600 will generally be held as shown in FIG. 8, such that device 600 is at an angle 618 to a vertical axis 620 that is vertical with respect to the ground or the earth.

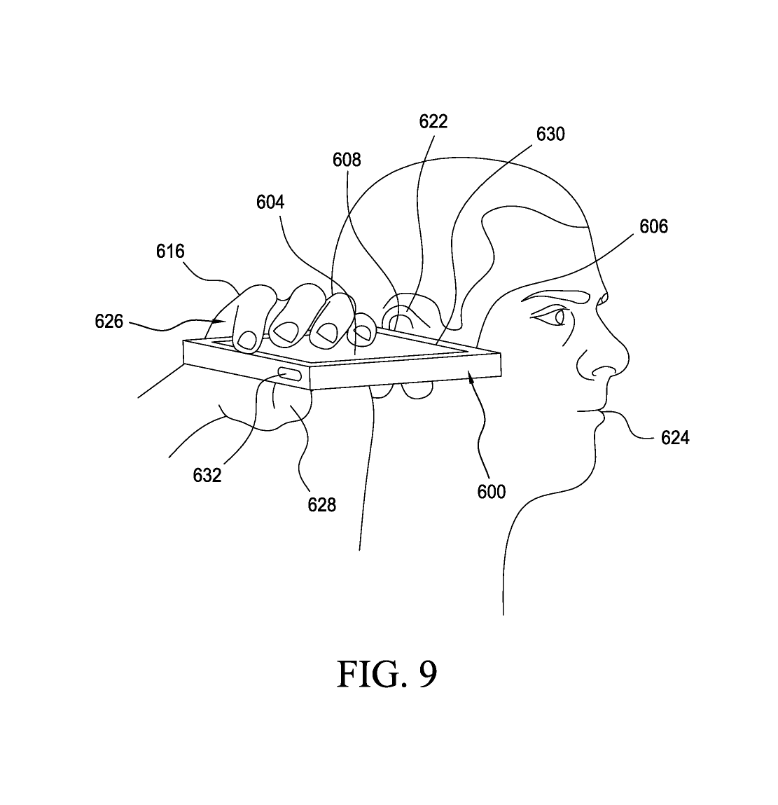

Once the phone number is entered or selected, mobile communication device 600 is typically shifted to a position such as that shown in FIG. 9, where speaker 608 is positioned near, adjacent, alongside, or on a user ear 622, and microphone 606 is oriented toward a user mouth 624. To position microphone 606 and speaker 608 as shown in FIG. 9, fingers 626 or thumb 628 are likely to contact display 604, which in a conventional mobile communication device would be active and capable of receiving input. However, mobile communication device 600 is configured to recognize when device 600 is being used to make a call, and automatically deactivates input to display 604 during the call, as described in more detail hereinbelow.

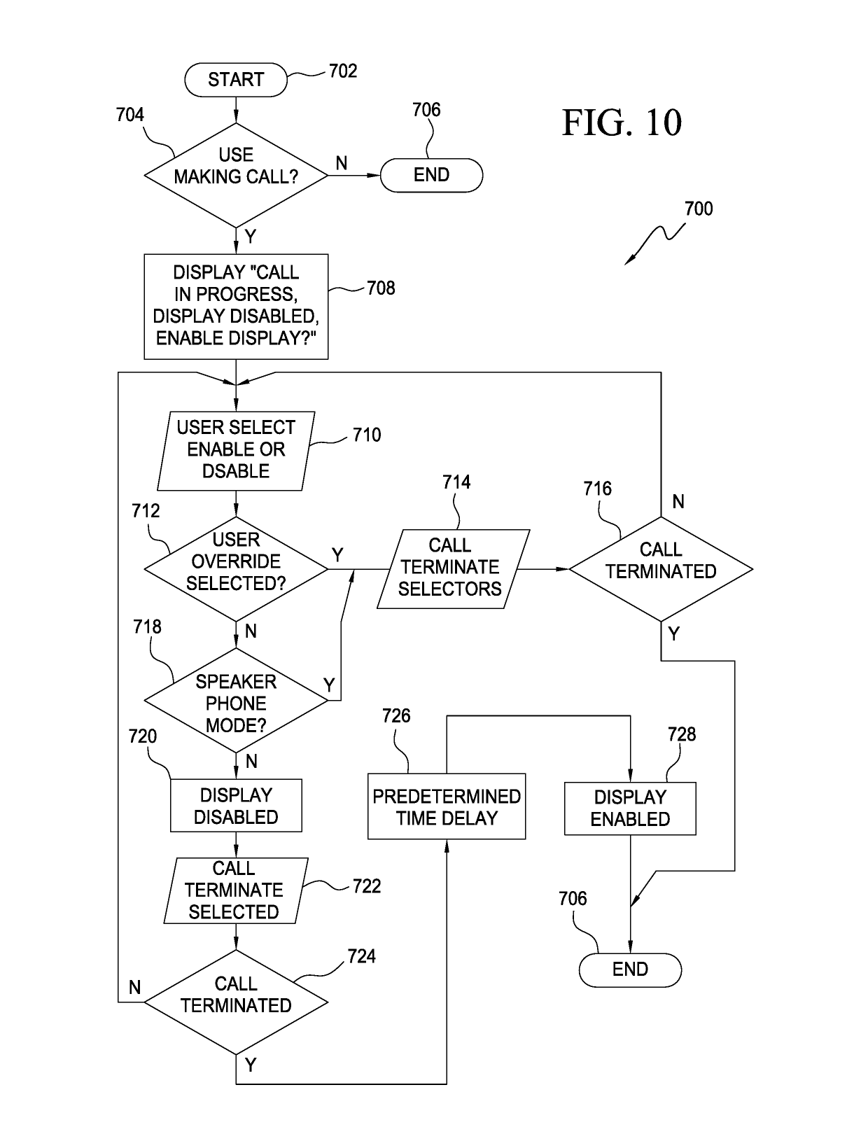

FIG. 10 shows a process flow, indicated generally at 700, for a display input process in accordance with an exemplary embodiment of the present disclosure. It should be understood that display input process 700 can be a subroutine of another process, and can thus be called by another process. Accordingly, when display input process 700 “ends,” control can pass from display input process 700 to the calling process. The calling process can then call process 700 again to determine whether the display should be controlled as disclosed in process 700.

Display input process 700 begins with a start process 702, in which registers may be cleared, initial variable values may be established, communication with various elements of a mobile communication device occur, etc. Upon completion of start process 702, control passes from start process 702 to a user making call decision process 704.

In user call decision process 704, it is determined whether the user is in the process of making a telephone call. If the user is not making a call, control passes from user call decision process 704 to an end process 706, which, as described elsewhere herein, can return control to another process or a calling process. Thus, display input process 700 can be checked periodically, which can be many times per second, to determine whether a call is being made by the user on the mobile communication device. If the user is making a call, control passes from user call decision process 704 to a display process 708.

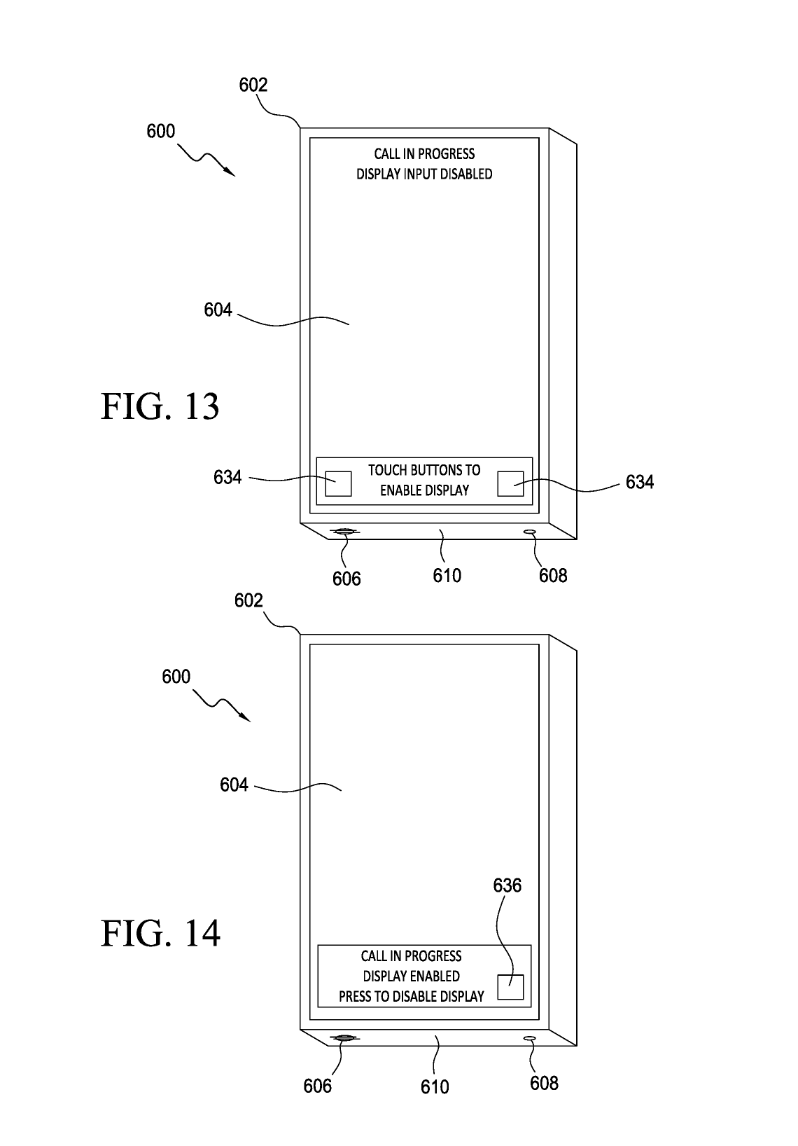

In display process 708, an indication that a call is in process is presented on, for example, display 604 of mobile communication device 600 shown in FIG. 8, along with one or more displayed icons, soft buttons, or keys 634, such as is shown in FIG. 13, which can provide an option to override disabling of input to display 604. Control then passes from display process 708 to an enable input process 710.

As shown in FIG. 13, one or more icons, soft buttons, or keys 634 can be displayed on display 604. In order to enable operation of display 604 at enable input process 710, an operator can contact one or more icons, soft buttons, or keys 634. To prevent unintentional enabling of display 604, operation of more than one icon, soft button, or key 634 can be required. For example, to enable operation of display 604, left icon, soft button, or key 634 can be pressed followed by right icon, soft button, or key 634, or the reverse order. In addition, actuation of the second of the two buttons can be within a timing window, such as within a time frame of 1 second or a half second, or less. Thus, if the second button is actuated outside of the timing window or time frame, which is, for example, greater than 1 second, then display 604 will not be enabled. It should be understood that actuation of icons, soft buttons, or keys 634 can be sensed by way of, for example, sensors 61, with signals from sensors 61 transmitted to and received by, for example, processor 96, described elsewhere herein. It should be understood that if the user does not select to enable display 604, the ability of display 604 to accept inputs other than inputs by way of icons, soft buttons, or keys 634 can be completely disabled. It should also be understood that while icons, soft buttons, or keys 634 are used as an exemplary example of a type of input to override disabling of display 604, other types of input overrides can be used. For example, when display 604 is disabled key or button 632 shown in, for example, FIG. 9 can be operated to enable display 604. One goal of such inputs to override disabling of display 604 is to make such override relatively easy to accomplish while holding mobile communication device 600 away from the ear, but relatively difficult to accomplish while holding mobile communication device 600 to an ear during a conversation.

Regardless of whether the user inputs to icons, soft buttons, or keys 634, or any other input to enable input to display 604, after a short, predetermined period or interval, such as one or two seconds, control passes from enable input process 710 to a user override decision process 712.

The explanation provided hereinabove with respect to enable input process 710 describes enabling a display. A user can also disable a previously enabled display during a call. For example, a user may wish to enable to a display to search for information, and after finding the information the user may wish to disable the display to prevent inadvertent operation of the display. The user may be presented with an icon, button, or soft key 636 shown in FIG. 14, which indicates that display 604 is enabled and that a call is in progress. The user of mobile communication device 600 can select, contact, press, or otherwise actuate icon, button, or soft key 636 to disable inputs to display 604, except to the extent such inputs might be allowed in a limited way, as described elsewhere herein. Regardless of whether display 604 is enabled or disabled, control passes from enable input process 710, which could also be described as enable/disable input process 710, to override decision process 712.

In override decision process 712, if the user has operated, for example, mobile communication device 600 to override disabling of display 604 at enable input process 710, control passes from override decision process 712 to a call terminated process 714.

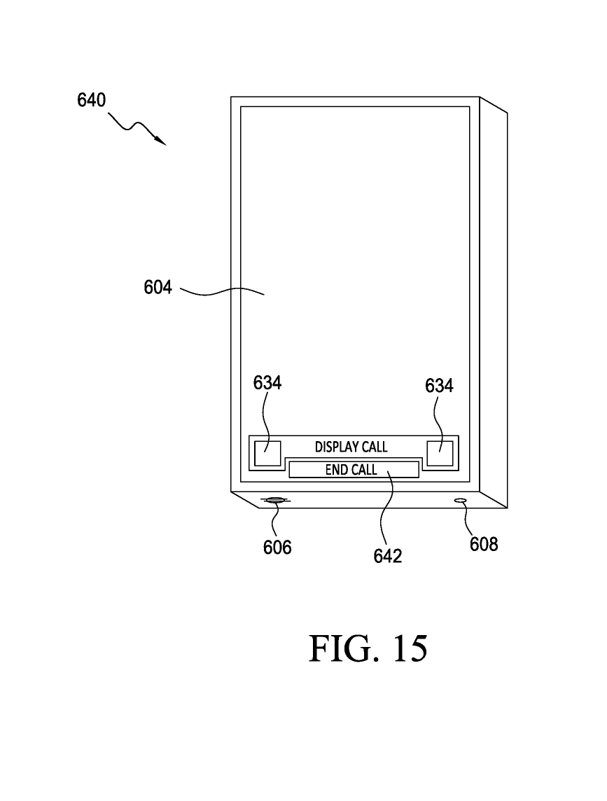

In call terminated process 714, the user operates a soft or hard key, button, or input to terminate a call, such as an icon, button, or soft key 642 positioned on display 604 of a mobile communication device 640, as shown in FIG. 15. A hard button can include a button or key on a headset, hand set, Bluetooth ear piece, watch, wearable device, wearable article, such as a hat or belt, and the like. It should be understood that call terminate key 642 is positioned at a location that is unlikely to be inadvertently activated during operation of mobile communication device 640, similar to a display enable icon, button, or soft key 642 similarly located at a bottom of mobile communication device 640 in a location that is near, alongside, adjacent, or in proximity to microphone 606 and speaker 608. After a predetermined period, such as about a half second or a full second, or a predetermined period in the range of a half second to a full second, control passes from call terminated process 714 to a call terminated decision process 716. If the user has not terminated the call, control passes from call terminated decision process 716 to enable input process 710, described elsewhere herein.

It should be understood that once the user has selected override to permit continued operation of the display, the user can continuously provide input to the display of the mobile communication device to control the mobile communication device. Control will continuously pass from process 712, to process 714, to process 716, to process 710, and to process 712 once the user has enabled operation of the display, until the display is disabled at enable input process 710 or until the call terminates. Of course, other conditions could stop operation of process 700, such as a battery of the mobile communication device running out of stored power, or a malfunction of the mobile communication device, and such situations can readily be incorporated in process 700. However, such functions are not shown in process 700 for the sake of clarity and brevity.

Returning to user override decision process 712, if the user does not select override or enable of display 604, or if the user has disabled display 604 after having previously enabled display 604, control passes from user override decision process 712 to a speaker phone decision process 718. In speaker phone decision process 718, it is determined whether the user has placed the mobile communication device in the speaker phone mode. If the speaker phone mode has been selected, control passes from speaker phone decision process 718 to call terminated process 714, which functions as described hereinabove. It should be apparent that operation in the speaker phone mode is functionally the same as the user selecting override or enabling the display. The reason for such capability is that in the speaker phone mode it is unlikely that the display will be inadvertently contacted, and the user may be using the display for other operations during a call.

If the speaker phone mode is not selected, control passes from speaker phone decision process 718 to a display disabled process 720. In display disabled process 720, all or part of the display can be disabled. A portion of the display, such as a portion 606 of display 604 shown in FIG. 9, icons, buttons, or soft keys 634 shown in FIG. 13, and soft key 642 shown in FIG. 15, can remain enabled to provide an input to enable the entirety of display 604. Alternatively, a hard key or button, such as a key or button 632 shown in FIG. 9, can be provided on mobile communication device 600 to provide a display enabling function during a call, or to call up or display an icon, button, or soft key to enable the entirety of the display. After the display is disabled, control passes from display disabled process 720 to a call terminated process 722.

In call terminated process 722, the user operates an icon, button, or soft or hard key, button, or input to terminate a call, such as icon, button, or soft key 642 positioned on display 604 of a mobile communication device 640, as shown in FIG. 15. It should be understood that call terminate key 642 is positioned at a location that is unlikely to be inadvertently activated during operation of mobile communication device 640, similar to a display enable icon, button, or soft key 642 similarly located at a bottom of mobile communication device 640 in a location that is near, alongside, adjacent, or in proximity to microphone 606 and speaker 608. After a predetermined period, such as about a half second or a full second, or a predetermined period in the range of a half second to a full second, control passes from call terminated process 722 to a call terminated decision process 724. If the user has not terminated the call, control passes from call terminated decision process 716 to enable input process 710, described elsewhere herein.

In call terminated decision process 724, it is determined whether the call has ended, which can be by the receiver hanging up or terminating the call, by a separate control, such as can be provided on a headset, earbud, or the like, by an icon, button, or soft key or button displayed on, for example, portion 630 of display 604, or by other inputs. If the call is not terminated, control passes from call terminated decision process 724 to enable input process 710, which operates as previously described. It should be understood that once the display or a portion of the display is disabled, it remains disabled until the operator provides a different input at enable input process 710, or the call terminates. If the call is terminated, control passes from call terminated decision process 724 to a predetermined time delay process 726.

Predetermined time delay process 726 provides a time for the user to reposition the hand to remove the fingers from the display. Thus, at the end of the predetermined interval or period, it is expected that the fingers will no longer be positioned on the display. The predetermined period can be adjustable by the user. Thus, if an initial predetermined period is, for example, one second or two seconds, the user may be able to decrease the initial predetermined period to an interval or period that is longer than two seconds or shorter than one second. Once predetermined time delay process 726 is complete, control passes from predetermined time delay process 726 to a display enable process 728.

In display enable process 728, the display is enabled for typical, standard, or normal input. Thus, any restrictions placed on input into the display are removed in this process. Control then passes from display enable process 728 to end process 706, described elsewhere herein.

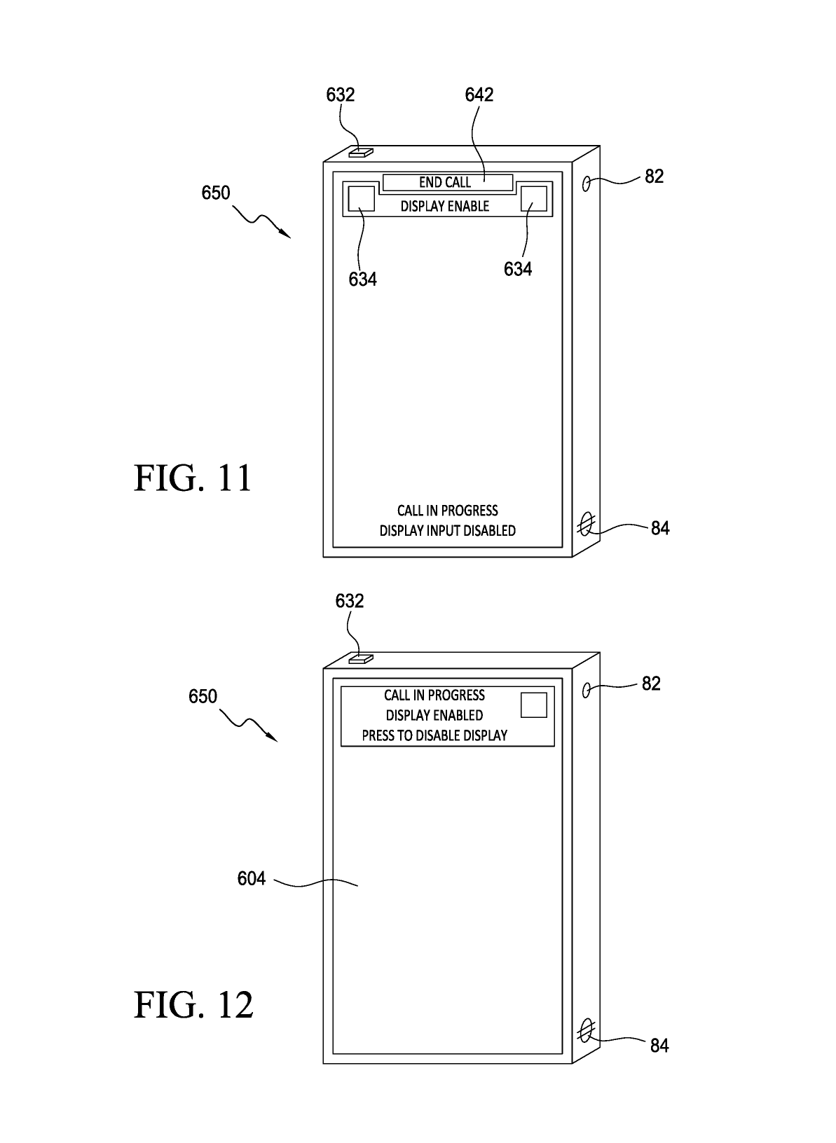

Other speaker and microphone configurations can use other positions of buttons and keys, including icons, soft buttons, and soft keys. For example, FIGS. 11 and 12 show a mobile communication device 650 that includes previously described features and elements, which are similarly labelled as previously described features and elements. Because mobile communication device 650 is similar to mobile communication device 50 which is shown being held as shown in FIG. 3, the placement of icons, soft buttons, or keys 634 is at or near a top portion of display 604, with at least one icon, button, or soft key or button near, adjacent, close, in proximity, or alongside to speaker 82. As with the embodiment of FIG. 13, pressing two icons, buttons, or soft keys decrease the risk of inadvertent enablement of display 604.

For the sake of brevity, embodiments were shown as exemplary devices. Any part of any embodiment can be used in combination to create a single embodiment, and any part of any embodiment can be used as a replacement or addition to another embodiment, and any combination of embodiments can be considered a single embodiment, and all resultant embodiments are within the scope of the present disclosure.

While various embodiments of the disclosure have been shown and described, it should be understood that these embodiments are not limited thereto. The embodiments may be changed, modified, and further applied by those skilled in the art. Therefore, these embodiments are not limited to the detail shown and described previously, but also include all such changes and modifications.

I claim:

1. A mobile communication device, comprising:
a casing;
a display positioned on or in the casing, the display including an input device;
a microphone positioned on the casing;
an antenna positioned on or in the casing, the antenna configured to wirelessly transmit signals received from the microphone, and to receive signals transmitted wirelessly; and
a speaker positioned on the casing, the speaker configured to emit audio signals based upon the wirelessly received signals from the antenna;
wherein when the mobile communication device wirelessly transmits signals received from the microphone and wirelessly receives signals that are converted to audio by the speaker, at least a portion of the display is automatically disabled from receiving an input from the input device.

2. The mobile communication device of claim 1, wherein a portion of the display includes at least one input icon or button operable to enable at least a portion of the disabled portion of the display.

3. The mobile communication device of claim 2, wherein when the display is enabled, the display is operable to again disable the at least a portion of the display.

4. A mobile communication device, comprising:
a casing including a front side, a back side, and a plurality of sides connecting the front side to the back side;
a display positioned on or in the front side of the casing, the display including an input device that operates by at least one of a proximity to, a contact with, and a pressure on a surface of the display by an object;
a microphone positioned on or adjacent to one of the plurality of sides connecting the front side to the back side;
an antenna positioned on or in the casing, the antenna configured to wirelessly transmit signals received from the microphone, and to receive signals wirelessly; and
a speaker positioned on or adjacent to the same one of the plurality of sides connecting the front side to the back side, the speaker configured to emit audio signals based upon the wirelessly received signals from the antenna;
wherein when the mobile communication device wirelessly transmits signals received from the microphone and wirelessly receives signals that are converted to audio by the speaker, at least a portion of the display is automatically disabled from receiving an input from the input device.

5. The mobile communication device of claim 4, wherein a portion of the display includes at least one input icon or button operable to enable at least a portion of the disabled portion of the display.

6. The mobile communication device of claim 5, wherein when the display is enabled, the display is operable to again disable the at least a portion of the display.

7. The mobile communication device of claim 4, wherein a portion of the display includes at least two input icons or buttons operable to enable at least a portion of the disabled portion of the display.

8. The mobile communication device of claim 7, wherein when the display is enabled, the display is operable to again disable the at least a portion of the display.

9. The mobile communication device of claim 8, wherein the at least two input icons or buttons must each be pressed to enable the at least a portion of the disabled portion of the display.

10. The mobile communication device of claim 8, wherein the two input icons or buttons must each be pressed within a predetermined period to enable the at least a portion of the disabled portion of the display.

11. The mobile communication device of claim 10, wherein the predetermined period is less than one second.

12. The mobile communication device of claim 4, wherein the at least a portion of the display remains disabled until communication between the speaker, microphone, and antenna is terminated or until a control of the mobile communication device is operated to enable at least a portion of the disabled portion of the display.

13. The mobile communication device of claim 12, wherein after communication between the speaker, microphone, and antenna is terminated, the disabled portion of the display is enabled automatically after a predetermined time.

14. The mobile communication device of claim 13, wherein the predetermined time is adjustable by a user.

15. A mobile communication device, comprising:
a housing or casing including a front side, a back side, and a plurality of sides connecting the front side to the back side;
a display positioned on or in the front side of the housing or casing, the display including an input device that operates by at least one of a proximity to, a contact with, and a pressure on a surface of the display by an object;
a microphone positioned on or adjacent to one of the plurality of sides connecting the front side to the back side;
an antenna positioned on or in the housing or casing, the antenna configured to wirelessly transmit signals received from the microphone, and to receive signals wirelessly; and
a speaker positioned on or in the housing or casing at a location that is spaced away from a top of the housing or casing, the speaker configured to emit audio signals based upon the wirelessly received signals from the antenna;
wherein when the mobile communication device wirelessly transmits signals received from the microphone and wirelessly receives signals that are converted to audio by the speaker, at least a portion of the display is automatically disabled from receiving an input from the input device.

16. The mobile communication device of claim 15, wherein a portion of the display includes at least one input icon or button operable to enable at least a portion of the disabled portion of the display.

17. The mobile communication device of claim 16, wherein when the display is enabled, the display is operable to again disable the at least a portion of the display.

18. The mobile communication device of claim 15, wherein a portion of the display includes at least two input icons or buttons operable to enable at least a portion of the disabled portion of the display.

19. The mobile communication device of claim 18, wherein when the display is enabled, the display is operable to again disable the at least a portion of the display.

20. The mobile communication device of claim 19, wherein the at least two input icons or buttons must each be pressed to enable the at least a portion of the disabled portion of the display.

21. The mobile communication device of claim 19, wherein the two input icons or buttons must each be pressed within a predetermined period to enable the at least a portion of the disabled portion of the display.

22. The mobile communication device of claim 21, wherein the predetermined period is less than one second.

23. The mobile communication device of claim 15, wherein the at least a portion of the display remains disabled until communication between the speaker, microphone, and antenna is terminated or until a control of the mobile communication device is operated to enable at least a portion of the disabled portion of the display.

24. The mobile communication device of claim 23, wherein after communication between the speaker, microphone, and antenna is terminated, the disabled portion of the display is enabled automatically after a predetermined time.

25. The mobile communication device of claim 24, wherein the predetermined time is adjustable by a user.
